(19) United States
(12) Patent Application Publication
(10) Pub. No.: US 2026/0266043 A1
(43) Pub. Date: Sep. 10, 2026

(54) MODULAR DOWEL BASKET

(71) Applicant: Luis Enrique ROMERO UREÑA, Guadalajara (MX)

(72) Inventor: Luis Enrique ROMERO UREÑA, Guadalajara (MX)

(73) Assignee: Luis Enrique ROMERO UREÑA, Guadalajara (MX)

(21) Appl. No.: 19/473,840

(22) PCT Filed: Apr. 8, 2024
(86) PCT No.: PCT/IB2024/053448

§ 371 Date: Oct. 9, 2025

(30) Foreign Application Priority Data
Apr. 10, 2023 (MX) MX/A/2023/004158

(51) Int. Cl. E04B 1/48; E01C 11/14

(52) U.S. Cl. CPC E04B 1/48; E01C 11/14

(57) ABSTRACT

The modular dowel basket assembly includes a modular dowel basket, an easy locking element, and a dowel bar, which when assembled configure a unit A. Additionally, the assembly can include a height support, which when assembled with the modular dowel basket, the easy locking element, and the dowel bar, configures a unit B. The modular dowel basket assembly is assembled in modules to achieve the desired height and length, and its manufacturing process allows for low production costs. Being modular, it allows for savings in storage, logistics, and transportation. The geometry and structure, as well as the plastic material from which the basket is made, provide the necessary flexibility and rigidity to keep the dowel bars correctly positioned and aligned.

### FIELD OF THE INVENTION

The present invention relates to a modular dowel basket assembly, which can be easily assembled on-site to any required size, and that keeps the dowel bars in the correct position. It also allows for storage in small spaces and optimizes the distribution and logistics chain, preventing deformation and excessive waste during transport.

### BACKGROUND OF THE INVENTION

There is currently a need to optimize the storage and distribution of these products, as well as to avoid the waste generated when placing dowel baskets, since they are manufactured to a specific size, and it is very common to have to place two or more and cut a section to fit the required measurement.

They also present the problem of requiring large spaces for storage, and when distributed, they occupy a large space and become entangled with each other, causing deformations.

Currently, there are steel and plastic dowel baskets on the Mexican and international markets, but none with the characteristic of being modular.

The steel ones present the problem of storage and distribution, since they leave the factory assembled and to a specific size. Being made of steel, they rust, reducing their lifespan due to the corrosion that rust generates in the steel.

The plastic ones are not modular and have the following problems:

If they are of the type that require assembly, they present the problem that several pieces are required to be assembled, the exact required spacing is not guaranteed, and the dowel bar is prevented from moving in the required direction at one of its ends.

If they are of the type that do not require assembly, they present the problem of being of a specific size, causing the same problems as the steel ones. These, being large pieces, tend to be more expensive than steel ones because they require large injection molding machines and a costly manufacturing process, in addition to also presenting the problem of preventing the dowel bar at one of its ends from moving in the required direction.

### BRIEF DESCRIPTION OF THE DRAWINGS

FIG. 1 shows a top isometric view of a modular dowel basket.

FIG. 2 shows a bottom isometric view of the modular dowel basket.

FIG. 3 shows a top plan view of the modular dowel basket.

FIG. 4 shows a bottom plan view of the modular dowel basket.

FIG. 5 shows a front view of the modular dowel basket.

FIG. 6 shows a rear view of the modular dowel basket.

FIG. 7 shows a right side view of the modular dowel basket.

FIG. 8 shows a left side view of the modular dowel basket.

FIG. 9 shows a top isometric view of the easy locking element of the modular dowel basket.

FIG. 10 shows a bottom isometric view of the easy locking element of the modular dowel basket.

FIG. 11 shows a top plan view of the easy locking element of the modular dowel basket.

FIG. 12 shows a bottom plan view of the easy locking element of the modular dowel basket.

FIG. 13 shows a front view of the easy locking element of the modular dowel basket.

FIG. 14 shows a rear view of the easy locking element of the modular dowel basket rotated 180°.

FIG. 15 shows a right side view of the easy locking element of the modular dowel basket.

FIG. 16 shows a left side view of the easy locking element of the modular dowel basket.

FIG. 17 shows an isometric detail of the tightening wedges for the dowel bar of the modular dowel basket.

FIG. 18 shows a side cross-sectional detail of the tightening wedges for the dowel bar of the modular dowel basket.

FIG. 19 shows an isometric detail of the anchoring wedge for the union of the modular dowel basket.

FIG. 20 shows a side cross-sectional detail of the anchoring wedge for the union of the modular dowel basket.

FIG. 21 shows an isometric detail of the anchoring zone where the anchoring wedge for the union of the modular dowel basket is anchored.

FIG. 22 shows an isometric detail of the zone where the easy locking element is inserted into the modular dowel basket.

FIG. 23 shows a side cross-sectional detail of the zone where the easy locking element is inserted into the modular dowel basket.

FIG. 24 shows an isometric detail of the easy locking element in the modular dowel basket in the locking position for the dowel bar.

FIG. 25 shows an isometric detail of the easy locking element in the modular dowel basket in the free position for the dowel bar.

FIG. 26 shows an isometric view of the first assembly sequence of the dowel bar in the modular dowel basket to form unit A.

FIG. 27 shows an isometric view of the second assembly sequence of the dowel bar with a second modular dowel basket to form unit A.

FIG. 28 shows an isometric view of unit A.

FIG. 29 shows an isometric view of the assembly between one unit A and another unit A of the modular dowel baskets.

FIG. 30 shows an isometric view of several units A of the modular dowel baskets.

FIG. 31 shows the assembly sequence of the height support to form unit B.

FIG. 32 shows an isometric view of unit B.

FIG. 33 shows an isometric view of several units B of the modular dowel basket.

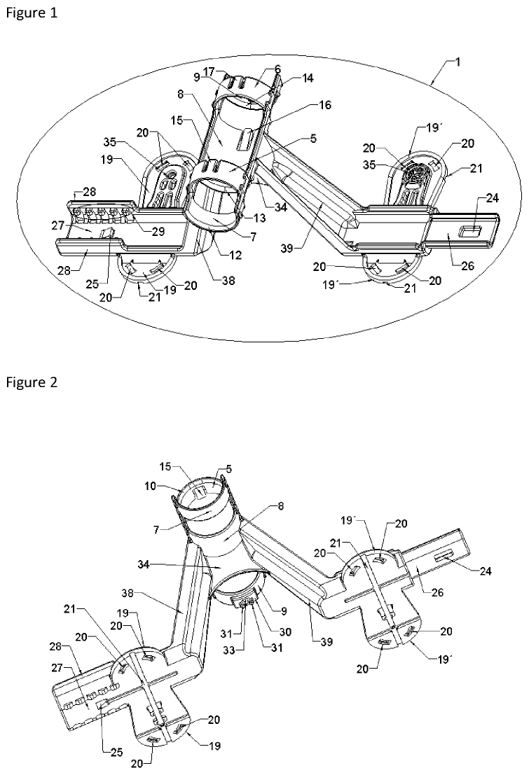

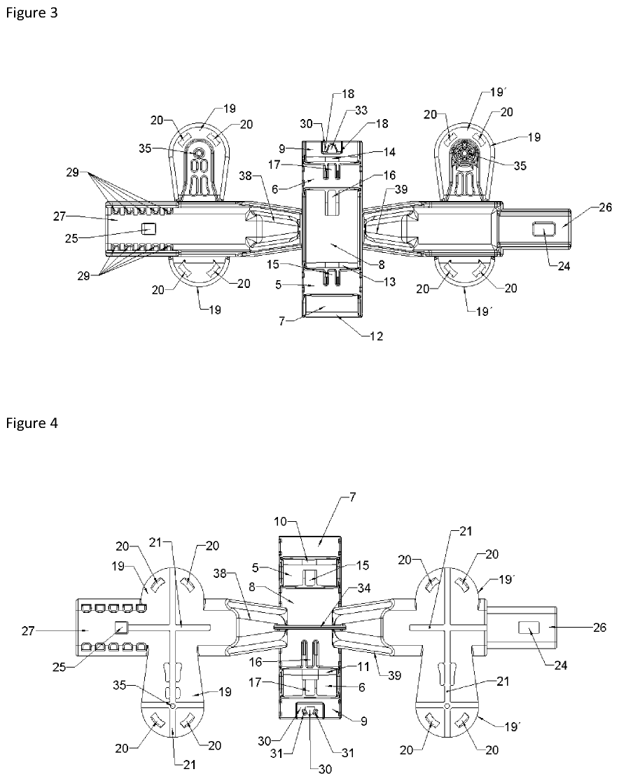

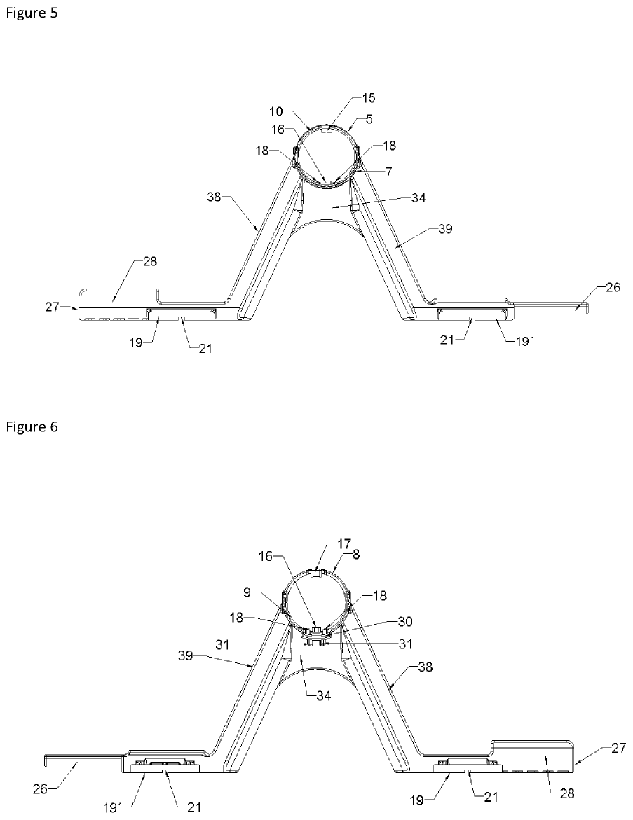

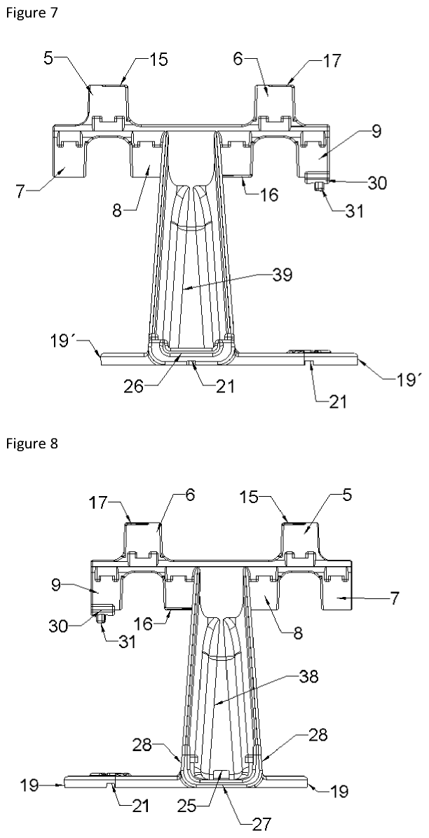

### DETAILED DESCRIPTION OF THE INVENTION

Modular dowel basket assembly, which forms a structure for the required function, with the versatility of being modular. Because it is modular and easy to assemble, it reduces material waste since it can be assembled on-site with the appropriate dimension. It also reduces the need for large storage spaces and lowers distribution costs, because wasted space during transport is avoided.

As shown in the figures, the modular dowel basket assembly is made up of three pieces: a modular dowel basket (1), an easy locking element (2) and a dowel bar (3), which when assembled allow configuring a unit A (36).

Additionally, the modular dowel basket assembly may include a height support (4), which when assembled with the modular dowel basket (1), the easy locking element (2) and the dowel bar (3), allow configuring a unit B (37).

The modular dowel basket (1), the easy locking element (2) and the height support (4) are made of plastic materials, and the dowel bar (3) is made of metallic materials, preferably using smooth steel bar from grade 42 to grade 60.

The modular dowel basket (1) is made up of an arrangement of five interconnected half-round channels, a first lower half-round channel (7), a first upper half-round channel (5) located on the first lower half-round channel (7), a second lower half-round channel (8) and a third lower half-round channel (9), the second lower half-round channel (8) being located between the first lower half-round channel (7) and the third lower half-round channel (9), and a second upper half-round channel (6) located on the third lower half-round channel (9); a pair of structural elements (38) and (39) that extend downwards from the sides of the second lower half-round channel (8), one structural element for each side, in order to form an inverted “V”, with the arms of the “V” forming a variable angle, according to the design requirements; a horizontal male stepped end (26), located at the lower end of the structural element (39); a horizontal female end (27), located at the lower end of the structural element (38); a first anchoring zone (19) that is located transversely on the lower face of the female end (27); and, a second anchoring zone (19′) that is located transversely on the lower face of the male stepped end (26). The anchoring zones (19) and (19′) allow anchoring the modular dowel basket (1) to the floor where they will be placed, in addition to allowing the anchoring of the height supports (4).

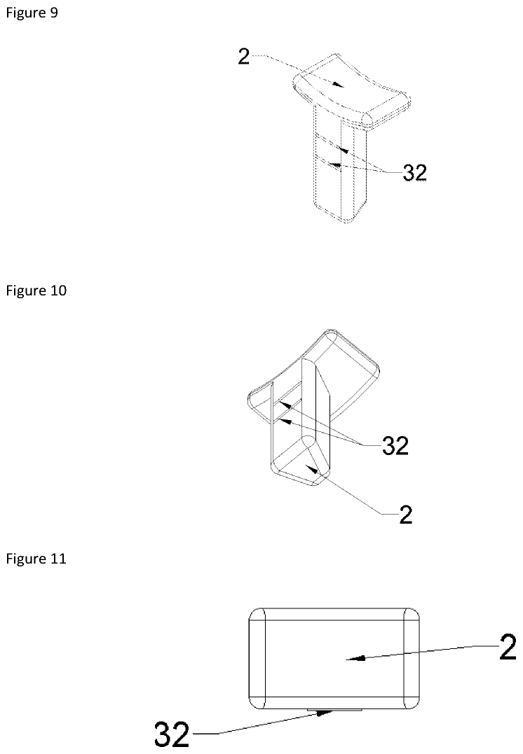

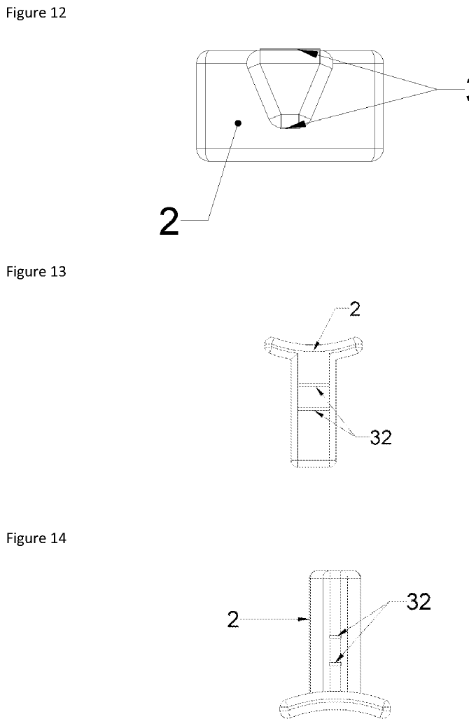

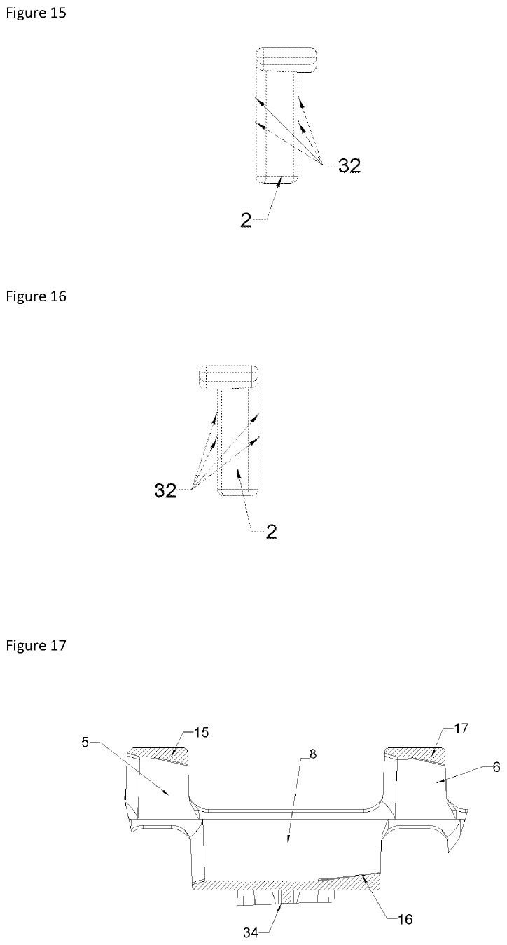

The easy locking element (2) shown in FIGS. 9 to 16, is made up of a structural element in the shape of a “T”, where the upper end of the “T” is concave rectangular in shape and the stem of the “T” is in the shape of a triangular prism, in whose intermediate section of the front and rear faces, a pair of anchoring ribs (32) of the easy locking element (2) are located.

The concavity of the upper end of the “T” allows the free passage of the dowel bar (3) in the third lower half-round channel (9), when the easy locking element (2) is completely inserted into the easy lock housing (30).

The dowel bar (3) is made up of a structural element of elongated cylindrical shape, which is preferably a steel bar that during the assembly of at least two modular dowel baskets (1), is inserted into the half-round channels (5), (6), (7), (8) and (9) until it stops against the easy locking element (2).

The main characteristic of the dowel bar (3) is to transfer the load that a system of load-bearing slabs can receive, during the assembly and operation of the modular dowel basket assembly (1).

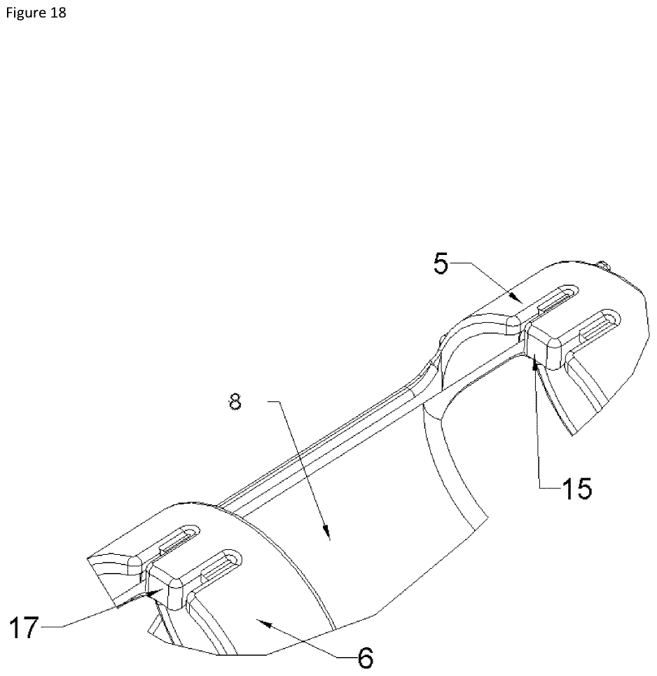

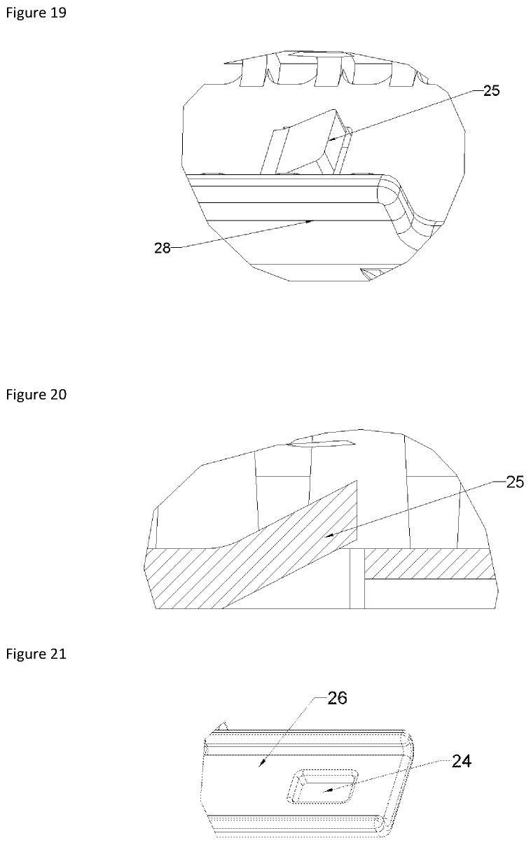

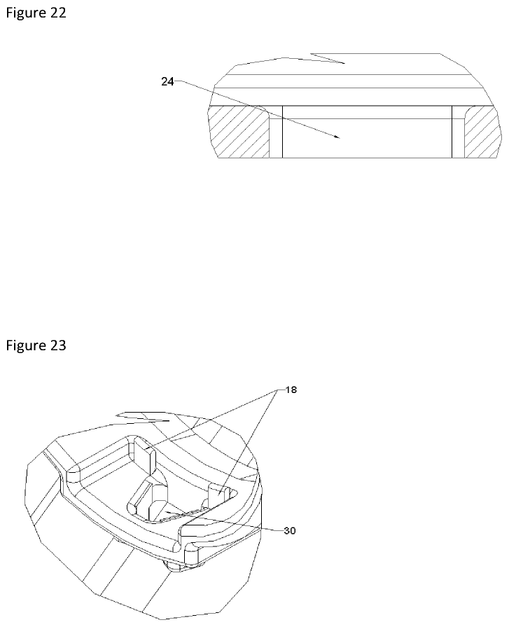

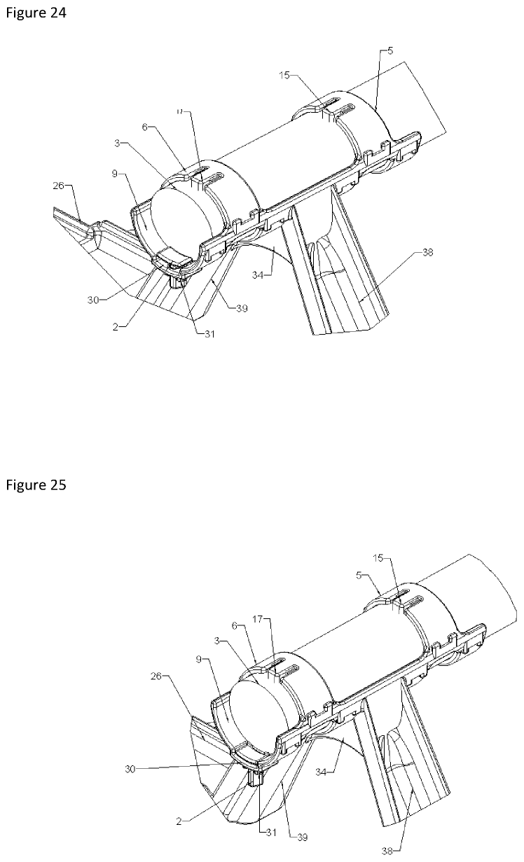

With respect to the tightening wedges shown in FIGS. 17 and 18, the first tightening wedge (15) is located in the upper right part of the first upper half-round channel (5), the second tightening wedge (16) is located in the lower right part of the second lower half-round channel (8) and the third tightening wedge (17) is located in the upper right part of the second upper half-round channel (6), of the modular dowel basket (1).

The tightening wedges (15), (16) and (17) share three essential characteristics, the three tightening wedges are located at the right ends of the half-round channels where they are located, all three have an angle which favors the entry of the dowel bar (3), said angle starting flush with the internal part of the half-round channels and ending at the right end of each of the half-round channels where the tightening wedges are located. By having a greater thickness at the end of the angle of the tightening wedge, a natural resistance is caused that pushes the dowel bar (3) against the internal walls of the half-round channels that are on the sides of the half-round channels that have the tightening wedges.

The anchoring wedge (25) is located on the upper face of the base of the female end (27) and projects upwards at an angle that ends up protruding from the upper part of said end, this angle favors the entry of the male stepped end (26) into the female end (27), the function of the anchoring wedge (25) is to prevent the male stepped end (26) from moving in the opposite direction to which it was inserted.

The rectangular anchoring groove (24) is located on the male stepped end (26), to allow the entry of the anchoring wedge (25) in its entirety, when the male stepped end (26) of a first modular dowel basket (1) is inserted into the female end (27) of a second modular dowel basket (1), until the anchoring wedge (25) of the female end (27) fully enters the rectangular groove (24), so that said wedge (25) engages with the walls of the rectangular anchoring groove (24), so that together an anchor is formed to prevent the two modular dowel baskets (1) from separating. This operation is repeated successively until the desired length is achieved.

The anchoring system in the easy locking element (2) consists of at least one pair of transverse anchoring ribs (32), which are located in the intermediate section of the front and rear faces of the triangular body of the easy locking element (2), so that during assembly they can be anchored in the triangular hole (33) that is in the easy lock housing (30), so that together with the ribs (31) of the easy lock housing (30), they allow for the anchoring.

The triangular easy lock hole (33) has this shape so that it can only be inserted in one way; in addition, to give a resistance structure to the triangular easy lock hole (33), it has reinforcing ribs (31) that are located in the lower part of the easy lock housing (30), attached to the two walls of the triangular easy lock hole (33).

During assembly, the easy locking element (2) is positioned in the easy lock housing zone (30) that has a triangular section easy lock hole (33), which allows the easy locking element (2), which is also of triangular section, to be properly positioned.

The easy lock housing (30) is located at the lower right end of the third lower half-round channel (9), being in low relief with respect to the internal part of the third lower half-round channel (9), in order that the easy locking element (2) enters completely when it is required that the dowel bar (3) does not have the limitation of the easy locking element (2). This zone includes the housing (30), where a triangular-shaped easy lock hole (33) is located for the triangular stem of the easy locking element (2) to enter, which has a pair of ribs (31) that are located on the outer part of the third lower channel (9) and that serves to give a structure to the triangular easy lock hole (33), in addition to serving so that the easy lock anchor (32) can act.

Another anchoring zone of the modular dowel basket (1) are the anchoring zones (19) and (19′), the first anchoring zone (19) is located transversely on the lower face of the horizontal female end (27), which is interconnected with the lower end of the structural element (38); and, the second anchoring zone (19′) is located transversely on the lower face of the horizontal male stepped end (26), which is interconnected with the lower end of the structural element (39). These two anchoring zones (19) and (19′) have the characteristic of being able to anchor the modular dowel basket (1) to the floor where it will be installed, as well as anchoring the height supports (4), which means that only the basket (1) can be anchored to the floor or the support (4) can also be anchored to the floor.

To prevent the sliding of the modular dowel basket (1) and the support (4), there are anti-slip rails (21) located centrally on the lower face of the anchoring zones (19) and (19′) of the female ends (27) and male stepped end (26) respectively. The anti-slip rails (21) in the described embodiment preferably have the shape of a cross, in order that the height support (4) is guided correctly. The anti-slip rails (21) can adopt any geometric shape, depending on the design requirements.

The anchoring zone of the height support (4) consists of a horizontal male stepped end (26), located at the lower end of the structural element (38); a horizontal female end (27), located at the lower end of the structural element (39); a first anchoring zone (19) that is located transversely on the male stepped end (26); and, a second anchoring zone (19′) that is located transversely on the female end (27).

The height support (4) is made up of a rectangular-shaped structural element, on whose upper face are located at its ends anchoring harpoons (22) and in its intermediate section, height and support ribs (23).

The height support (4) has at least four anchoring harpoons (22) and at least nine height and support ribs (23), the height of the anchoring harpoons (22) and the height and support ribs (23) is determined by the requirement of the total height required by the modular dowel basket (1), according to what is determined by the thickness of the slab where the modular dowel basket assembly (1) will be installed.

It is important to mention that the anti-slip rails (21) located centrally on the lower face of the anchoring zones (19) and (19′), in addition to preventing the sliding of the modular dowel basket (1), also allow to reduce the load on the anchoring harpoons (22) by preventing sliding in the height support (4).

For the assembly of unit A (36), the easy locking element (2) is inserted into the easy lock inlet (33) in a locking position, which occurs only when the first easy lock anchor (32) acts.

To prevent the easy locking element (2) from being placed incorrectly, the easy lock inlet (33) has a triangular shape, so that it can only be inserted in one way; in addition, to give a resistance structure to the easy lock inlet (33), it has reinforcing ribs (31) that are located in the lower part of the easy lock housing (30). Subsequently, the dowel bar (3) is inserted into five half-round channels of the modular basket (1), passing through the first lower half-round channel (7), then in the upper half-round channel (5), then through the second lower half-round channel (8), then the second upper half-round channel (6) and finally through the third lower half-round channel (9), until it stops against the distance stop (18) or the easy locking element (2) which also functions as a distance stop.

Because the dowel bar (3) has a polyurethane paint coating, this causes variations in the diameter of the dowel bar (3), therefore, the first lower half-round channel (7), first upper half-round channel (5), second lower half-round channel (8), second upper half-round channel (6) and third lower half-round channel (9) have a slightly larger diameter.

The first upper half-round channel (5) has an inlet chamfer (10) located at its left end on the inner part of the upper half-round channel (5), this is in order that when inserting the dowel bar (3) there is no limitation and it can enter easily; the first lower half-round channel (7) has an inlet chamfer (12) located at its left end on the inner part of the lower half-round channel (7), this is in order that when inserting the dowel bar (3) there is no limitation and it can enter easily; the second upper half-round channel (6) has an inlet chamfer (11) located at its left end on the inner part of the upper half-round channel (6), this is in order that when inserting the dowel bar (3) there is no limitation and it can enter easily; the second lower half-round channel (8) has an inlet chamfer (13) located at its left end on the inner part of the lower half-round channel (8), this is in order that when inserting the dowel bar (3) there is no limitation and it can enter easily; and, the third lower half-round channel (9) has an inlet chamfer (14) located at its left end on the inner part of the lower half-round channel (9), this is in order that when inserting the dowel bar (3) there is no limitation and it can enter easily.

To prevent the dowel bar (3) from coming out or separating from the distance stop (18) or the easy lock (2) of the modular basket (1), the first upper half-round channel (5) has the first tightening wedge (15), the second lower half-round channel (8) has the second tightening wedge (16) and the second upper half-round channel (6) has the third tightening wedge (17), which will always keep the dowel bar (3) in the correct position.

Once one of the ends of the dowel bar (3) is inserted into a modular basket (1), the other end of the dowel bar (3) is inserted into another modular basket (1) and thus unit A (36) is formed, which consists of five pieces that will give the required minimum height, which is from the floor where the modular basket (1) is placed to the center of the dowel bar (3). This unit A (36) is made up of two modular baskets (1), two easy locking elements (2) and one dowel bar (3).

For the assembly of unit B (37), the anchoring harpoons (22) of the height support (4) are inserted into the curved anchoring grooves (20) of the anchoring zone (19) of the height support (4), with the height and support ribs (23) having to be positioned within the anti-slip rails (21), once the two height supports (4) are placed in the modular basket (1), the dowel bar (3) is placed in the modular basket (1) in the same way as mentioned before and thus unit B (37) is formed, which consists of seven pieces that will give a greater height than that of unit A (36), which is from the floor where the modular basket (1) with height support (4) is placed to the center of the dowel bar (3). This unit B (37) is made up of two modular baskets (1), one dowel bar (3) and four height supports.

To give the necessary length in both unit A (36) and unit B (37), the male stepped end (26) of the modular basket (1) is inserted into the female end (27) of another modular basket (1), until the female end anchoring wedge (25) of the female end (27) fully enters the male end rectangular anchoring groove (24) of the male stepped end (26) of the other modular basket (1) and so on until the desired length is achieved.

This anchoring prevents the modular basket (1) from separating in the reverse direction to which they were inserted.

To prevent lateral displacements of the modular baskets (1) and prevent them from coming out of the proper position and from the anchoring between the male stepped end (26) and the female end (27). The female end (27) has two side walls (28) which prevent lateral displacements between the modular baskets (1). To prevent the modular baskets (1) from coming out of the anchoring and some modular basket (1) from being mounted on the other modular basket (1), the side walls (28) of the female end (27) have rail ribs (29) which, together with the side walls (28), enclose the male stepped end (26).

Once unit A (36) or unit B (37) is assembled with the desired length and placed in the indicated place, it is fastened with a nail that passes through the nail hole (35) and is nailed to the floor.

Once unit A (36) or unit B (37) with the desired length is fixed to the floor by being nailed to it, the easy locking element (2) of the modular baskets (1) is lowered in an interspersed manner, remaining perfectly in the easy lock housing (30). In case it is necessary and a person must stand, both on the modular baskets (1), and on units A (36) and B (37), the modular basket (1) has a load rib (34) that prevents deformations.

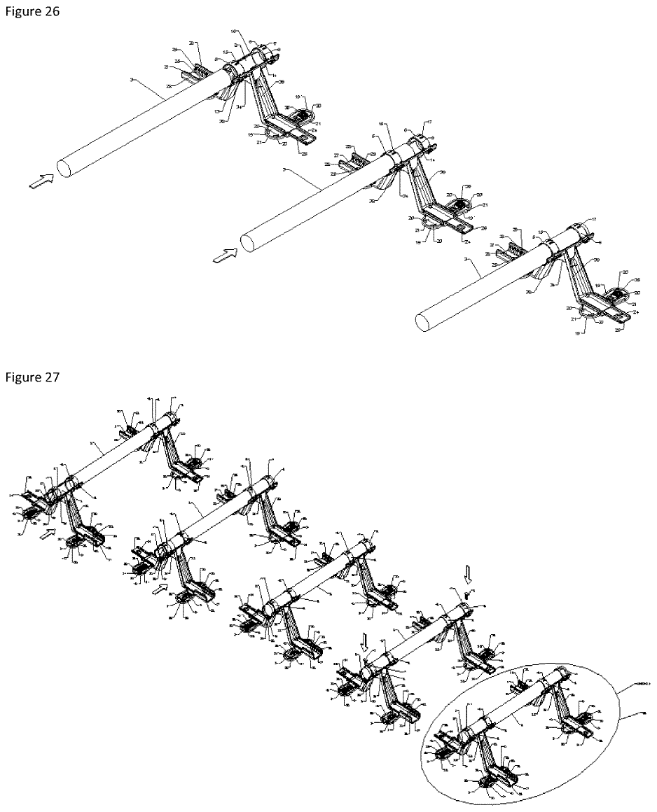

FIG. 26 clearly shows how the dowel bar (3) is inserted into the half-round channels of the modular dowel basket (1), in said figure it can be observed in the upper left image how the dowel bar (3) begins to be guided by the first lower half-round channel (7), to be able to be inserted into the first upper half-round channel (5) of the modular dowel basket (1).

In the middle image of FIG. 26, it is observed how the dowel bar (3) is guided by the first lower half-round channel (7), to be able to be inserted into the first upper half-round channel (5) and the second lower half-round channel and held by the first tightening wedge (15) which is in the first upper half-round channel (5) of the modular dowel basket (1).

In the lower right image of FIG. 26, it can be observed how the dowel bar (3) is already completely guided by the first lower half-round channel (7), first upper half-round channel (5), second lower half-round channel (8), second upper half-round channel (6) and the third lower half-round channel (9) and perfectly held by the first tightening wedge (15) which is in the first upper half-round channel (5), the second tightening wedge (16) which is in the second lower half-round channel (16) and the third tightening wedge (17) which is in the second upper half-round channel (9), of the modular basket (1). In this way, the first assembly sequence of unit A is obtained.

In FIG. 27, the same sequence is observed to introduce the opposite side of the dowel bar (3) into the modular basket (1).

In the first image on the upper left side, it is observed how the dowel bar (3) begins to be guided by the first lower half-round channel (7), to be able to be inserted into the first upper half-round channel (5) of the modular basket (1).

In the second image to the right of the first image, it is observed how the dowel bar (3) is guided by the first lower half-round channel (7), to be able to be inserted into the first upper half-round channel (5) and the second lower half-round channel and held by the first tightening wedge (15) which is in the first upper half-round channel (5) of the modular basket (1).

In the third image that is to the right of the second image, it can be observed how the dowel bar (3) is already completely guided by the first lower half-round channel (7), first upper half-round channel (5), second lower half-round channel (8), second upper half-round channel (6) and the third lower half-round channel (9) and perfectly held by the first tightening wedge (15) that is in the first upper half-round channel (5), the second tightening wedge (16) that is in the second lower half-round channel (8) and the third tightening wedge (17) that is in the second upper half-round channel (9), of the modular basket (1).

In the fourth image that is to the right of the third image, it is observed how and where the easy locking element (2) is inserted into the housing of the easy lock (30) of the modular basket (1).

In the fifth image, we can see unit A (enclosed in a circle), completely formed with all its pieces.

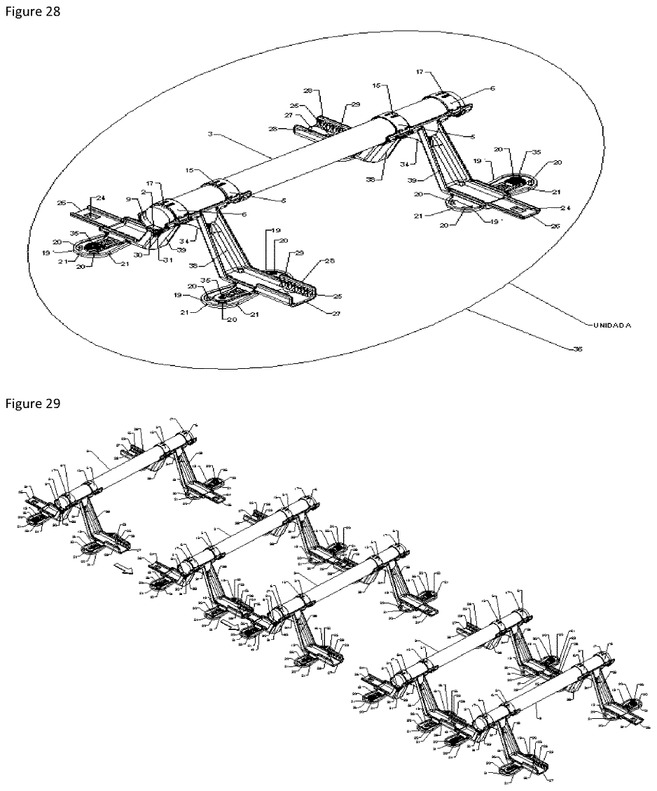

FIG. 28 clearly shows unit A being structured by two modular baskets (1), two easy locking elements (2) and one dowel bar (3).

FIG. 29 shows how units A are joined in the modular part.

In the first upper left image, it is observed how one unit A approaches another unit A.

In the second image that is to the right of the first image, it is observed how the units A begin to be inserted into the anchoring zones by means of the male stepped ends (26) and the female ends (27).

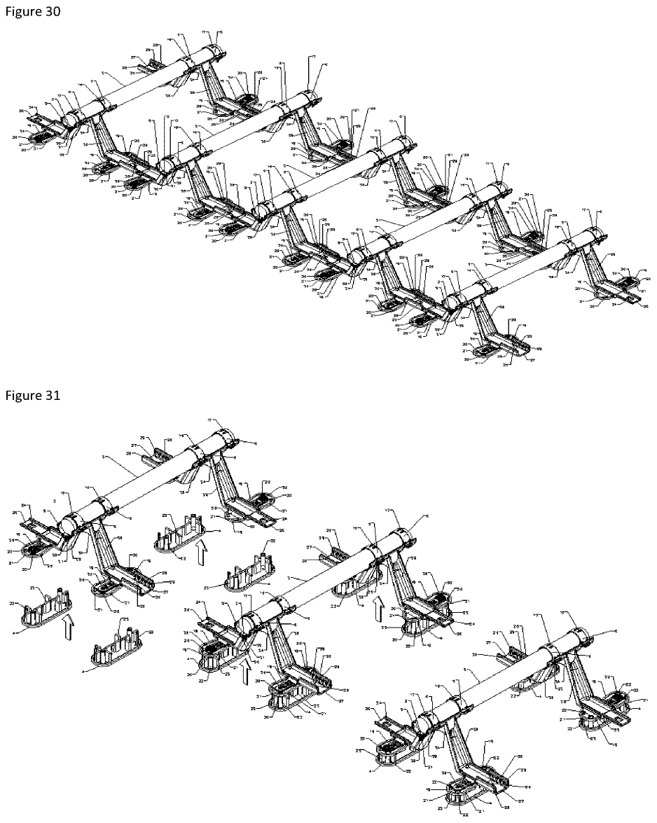

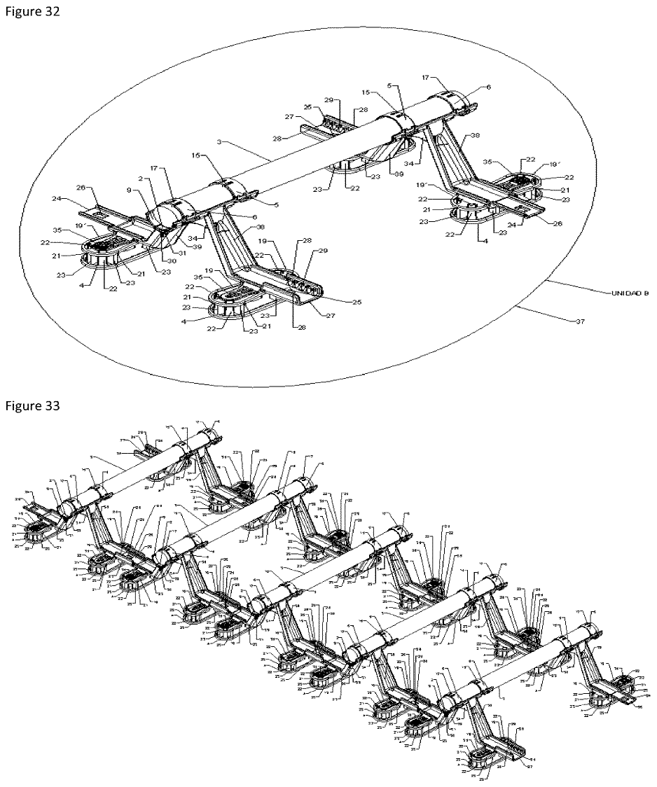

In the third image, it is observed how the male stepped ends (26) are completely inserted into the female ends (27), and being in this position they are anchored by the female end anchoring wedge (25) of the female end (27) having fully entered the male end rectangular anchoring groove (24) of the male stepped end (26) of the other modular basket (1) and so on until the desired length is achieved, as shown in FIG. 30.

FIG. 31 shows a sequence to obtain unit B. To be able to form unit B, supports (4) are placed on unit A, which are located in the anchoring zone (19) of the support (4), which is in the lower part of the modular dowel baskets (1).

The first upper left image of FIG. 31 shows unit A with the height supports (4), the middle image shows how the supports (4) begin to be positioned in the anchoring zone (19) of the support (4) which is in the lower part of the modular baskets (1) guided by the support anchoring harpoons (22), which begin to be inserted into the curved anchoring grooves (20) of the anchoring zone (19) of the support (4).

The third lower right image shows how the supports (4) are perfectly positioned in the anchoring zone (19) of the support (4) which is in the lower part of the modular baskets (1), once the anchoring harpoons (22) of the support (4) were inserted into the curved anchoring grooves (20) of the anchoring zone (19) of the support (4), anchoring the supports (4) in the anchoring zone (19) of the support (4) of the modular baskets (1).

Remaining perfectly structured to give a new height, this is because the anchoring harpoons (22) of the supports (4) are already anchored in the anchoring zone (19) of the support (4) of the modular baskets (1) and the height and support ribs (23) are already inside the anti-slip rails (21).

Although in the foregoing description a preferred embodiment of the present invention has been described and shown, it should be emphasized that numerous modifications thereto are possible, without departing from the true scope of the invention.

Therefore, the present invention should not be restricted except as required by the prior art and by the appended claims.

1. A modular dowel basket assembly, characterized in that it comprises a modular dowel basket, an easy locking element, and a dowel bar, which when assembled configure a unit A.

2. The modular dowel basket assembly according to claim 1, further characterized in that the assembly includes a height support which when assembled with the modular dowel basket, the easy locking element and the dowel bar, configures a unit B.

3. The modular dowel basket assembly according to claim 1, further characterized in that the modular dowel basket is formed by an arrangement of five interconnected half-round channels, a first lower half-round channel, a first upper half-round channel located above the first lower half-round channel, a second lower half-round channel and a third lower half-round channel, the second lower half-round channel being located between the first lower half-round channel and the third lower half-round channel, and a second upper half-round channel located above the third lower half-round channel; a pair of structural elements extending downward from the sides of the second lower half-round channel, one structural element for each side, so as to form an inverted “V”, with the arms of the “V” forming a variable angle, according to the design requirements; a horizontal male stepped end, located at the lower end of the structural element; a horizontal female end, located at the lower end of the structural element; a first anchoring zone which is located transversely on the lower face of the female end; and a second anchoring zone which is located transversely on the lower face of the male stepped end

4. The modular dowel basket assembly according to claim 3, further characterized in that the first upper half-round channel includes a first tightening wedge located in its upper part; the second lower half-round channel includes a second tightening wedge located in its lower part; and, the second upper half-round channel includes a third tightening wedge located in its upper part; the tightening wedges and having an angle that favors the entry of the dowel bar.

5. The modular dowel basket assembly according to claim 3, further characterized in that the first upper half-round channel has an inlet chamfer located at its left end in the inner part of the upper half-round channel; the first lower half-round channel has an inlet chamfer located at its left end in the inner part of the lower half-round channel; the second upper half-round channel has an inlet chamfer located at its left end in the inner part of the upper half-round channel; the second lower half-round channel has an inlet chamfer located at its left end in the inner part of the lower half-round channel; and, the third lower half-round channel has an inlet chamfer located at its left end in the inner part of the lower half-round channel.

6. The modular dowel basket assembly according to claim 3, further characterized in that the female end includes an anchoring wedge that is located on its upper face and projects upwards at an angle that ends up protruding from the upper part of said end, this angle favoring the entry of the male stepped end into the female end, to prevent the male stepped end from moving in the opposite direction to which it was inserted.

7. The modular dowel basket assembly according to claim 3, further characterized in that the male stepped end includes a rectangular anchoring slot that is located at the outer end of the male stepped end, to allow the entry of the anchoring wedge, when the male stepped end of a first modular dowel basket is inserted into the female end of a second modular dowel basket until the anchoring wedge of the female end fully enters the rectangular slot, so that said wedge locks with the walls of the rectangular anchoring slot, to prevent the two modular dowel baskets from separating.

8. The modular dowel basket assembly according to claim 1, further characterized in that the easy locking element is formed by a “T”-shaped structural element, wherein the upper end of the “T” is of a concave rectangular shape and the stem of the “T” is of a triangular prism shape, in whose intermediate section of the front and rear faces, a pair of anchoring ribs are located.

9. The modular dowel basket assembly according to claim 8, further characterized in that the anchoring system in the easy locking element consists of at least one pair of transverse anchoring ribs, which are located in the intermediate section of the front and rear faces of the triangular body of the easy locking element, so that during assembly they can be anchored in the triangular hole that is located in the easy lock housing, which includes housing ribs to allow anchoring.

10. The modular dowel basket assembly according to claim 9, further characterized in that the easy lock hole has a triangular shape, so that it can only be inserted in this way; in addition, to give it a resistance structure, it has reinforcing ribs that are located in the lower part of the easy lock housing, attached to the two walls of the triangular easy lock hole.

11. The modular dowel basket assembly according to claim 9, further characterized in that the easy lock housing is located at the lower right end of the third lower half-round channel, being in low relief with respect to the inner part of the third lower half-round channel, so that the easy locking element enters completely when it is required that the dowel bar does not have the limitation of the easy locking element this zone comprises the housing, where a triangular easy lock hole is located for the triangular stem of the easy locking element to enter, which has a pair of ribs that are located on the outer part of the third lower channel and that serves to give a structure to the triangular easy lock hole, in addition to serving so that the easy lock anchor can act.

12. The modular dowel basket assembly according to claim 3, further characterized in that the first anchoring zone is located transversely on the lower face of the horizontal female end, which is interconnected with the lower end of the structural element; and, the second anchoring zone is located transversely on the lower face of the horizontal male stepped end, which is interconnected with the lower end of the structural element; these two anchoring zones and have the characteristic of being able to anchor the modular dowel basket to the floor where it will be installed, as well as anchoring the height supports, so that only the basket can be anchored to the floor or the support can also be anchored to the floor.

13. The modular dowel basket assembly according to claim 1, further characterized in that the modular dowel basket has anti-slip rails located centrally on the lower face of the anchoring zones of the female ends and male stepped end respectively, the anti-slip rails preferably having the shape of a cross, and may adopt any geometric shape, depending on the design requirements.

14. The modular dowel basket assembly according to claim 1, further characterized in that the dowel bar is formed by an elongated cylindrical structural element, which is preferably a steel bar that during the assembly of at least two modular dowel baskets, is introduced into the half-round channels, until it stops against the easy locking element.

15. The modular dowel basket assembly according to claim 2, further characterized in that the height support is formed by a rectangular structural element, on whose upper face are located at its ends anchoring harpoons and in its intermediate section, height and support ribs.

16. The modular dowel basket assembly according to claim 15, further characterized in that the height support includes at least four anchoring harpoons and at least nine height and support ribs, the height of the anchoring harpoons and the height and support ribs is determined by the thickness requirements of the slab where the modular dowel basket assembly will be installed.
